(19) United States
(12) Patent Application Publication
(10) Pub. No.: US 2026/0297343 A1
(43) Pub. Date: Oct. 1, 2026

(54) BIMODAL BINDER COMPOSITIONS, PROCESSES OF MAKING BIMODAL BINDER COMPOSITIONS, AND FAST-DRYING AQUEOUS COMPOSITIONS COMPRISING A BIMODAL BINDER COMPOSITION

(71) Applicant: ROHM AND HAAS COMPANY, Collegeville, PA (US)

(72) Inventors: Eric C. GREYSON, Blue Bell, PA (US); Stephanie A. LONG, Collegeville, PA (US); Michael W. LEONARD, Collegeville, PA (US)

(21) Appl. No.: 19/477,605

(22) PCT Filed: May 6, 2024
(86) PCT No.: PCT/US2024/027951

§ 371 Date: Oct. 22, 2025

Related U.S. Application Data
(60) Provisional application No. 63/464,981, filed on May 9, 2023.

(51) Int. Cl. C09D 7/40; C09D 5/02; C09D 5/33

(52) U.S. Cl. CPC C09D 7/68; C09D 5/004; C09D 5/028; C09D 7/67

(57) ABSTRACT

Bimodal binder compositions comprise a first mode comprising particles and a second mode comprising particles. The particles of the first mode have an average particle size ranging from 200 nm to 650 nm, and the particles of the first mode contain at least one void. The particles of the second mode have an average particle size less than the average particle size of the particles of the first mode, and the particles of the second mode do not contain a void. The particles of the first mode and the particles of the second mode independently comprise a film forming polymer formed from, as polymerized units, one or more ethylenically unsaturated monomers.

### FIELD OF THE INVENTION

The present invention relates to bimodal binder compositions.

### BACKGROUND

Traffic paints have previously been formulated with a high loading of titanium dioxide (TiO₂) to improve the opacity of roadway markings made with such paints. The high cost of TiO₂ thus presents a quandary to the local, state and federal government agencies charged with maintaining roadway markings to provide adequate demarcation of traffic lanes for safety's sake.

One approach to reducing TiO₂ is to use alternate pigments and/or fillers. Various pigments and fillers such as lithopone, zinc oxide, barium sulfate, calcium sulfate, antimony oxide, clay, magnesium silicate, and others can be used to reduce TiO₂ content in many materials while obtaining similar color and opacity, however the reduction in TiO₂ is often minimal, and other properties, as well as cost are often disadvantaged.

A second approach to reducing the cost of providing roadway markings would be to replace all or part of TiO₂ with an opacifier that relies on voids or hollow spaces in the opacifier, for example, hollow core polymers. Hollow core polymers increase reflectance in two ways. First, the hollow core polymers help to space out any high-reflective inorganic pigments and prevent crowding. Second, the hollow core polymers scatter light because of the interface between the polymer surrounding the hollow core and the air inside the core.

Japanese Patent Publication JP 2004-263001A, discloses aqueous dispersion compositions comprising an aqueous dispersion of hollow core polymer pigment particles and road markings made with the compositions.

U.S. Pat. No. 7,645,815 discloses the use of fast-drying aqueous compositions comprising a hollow core binder of a first polymer having a glass transition temperature (Tg) of 50° C. or more containing one or more voids, and a second polymer substantially encapsulating the first polymer, where the second polymer has a Tg of −30° C. or more.

However, the hollow core polymers currently in use are unable to provide the combination of properties including low or zero TiO₂ loading, freeze-thaw stability, quick dry time or quick dry-to-no-pick-up time, and lightness or luminance, (e.g., L* in CIELAB color space or Y in CIE xyY color space) desired for road marking applications.

The present inventors have endeavored to provide a binder system for aqueous traffic paints that provides a low cost option for making roadway markings while providing a combination of properties desired for road marking applications.

### SUMMARY OF THE INVENTION

The present invention relates to bimodal binder compositions comprising a first mode comprising particles and a second mode comprising particles. The particles of the first mode have an average particle size ranging from 200 nm to 650 nm, and the particles of the first mode contain at least one void. The particles of the second mode have an average particle size less than the average particle size of the particles of the first mode, and the particles of the second mode do not contain a void. The particles of the first mode and the particles of the second mode independently comprise a film forming polymer formed from, as polymerized units, one or more ethylenically unsaturated monomers.

### DETAILED DESCRIPTION

The present invention also provides bimodal binder compositions, processes of making bimodal binder compositions, fast-drying aqueous composition and roadway markings and methods of making the same from the fast-drying aqueous compositions.

All ranges recited are inclusive and combinable. For example, average particle sizes that range 200 nanometers (nm) or more and that may range up to 650 nm, preferably up to 600 nm, more preferably, 250 nm or more or, more preferably, 300 nm or more would include average particle sizes of from 200 nm to 650 nm, or of from 250 to 650 nm, or of from 200 nm to 600 nm, or of from 250 nm to 600 nm, or of from 300 nm to 650 nm, or of from 300 nm to 600 nm.

Unless otherwise indicated, all temperature and pressure units are standard temperature and pressure (STP).

All phrases comprising parentheses denote either or both of the included parenthetical matter and its absence. For example, the phrase “(meth)acrylate” includes, in the alternative, acrylate and methacrylate; likewise, the phrase “(co)polymer” refers, in the alternative, to a polymer, a copolymer, a terpolymer, a tetrapolymer, a pentapolymer, etc.

As used herein, the term “average particle size” means the particle size as determined by CHDF (capillary hydrodynamic fractionation) using Matec CHDF-2000; Matec Applied Sciences, Northborough, Mass., or by light scattering (LS) using a BI-90 particle size analyzer, Brookhaven Instruments Corp. (Holtsville, N.Y.).

As used herein, the term “fast-drying aqueous composition” means that, when applied to a substrate, the composition forms a film having a dry through time such that a film thereof having a wet coating thickness of 330 microns displays a dry-through time of less than two hours at 90 percent relative humidity at 23° C. when air flow is restricted using a humidity chamber in accordance with ASTM D7539-10. The term “fast-drying aqueous binder composition” refers to an aqueous polymer dispersion comprising one or more binder that, when applied to a substrate, forms a film having a dry-through time conforming to the definition of “fast-drying”; thus, one component fast-drying aqueous compositions comprise fast-drying aqueous hollow core binders. The term “two component fast-drying aqueous composition” refers to an aqueous polymer composition comprising one or more binder and an absorber component that when applied to a substrate, forms a film having a dry-through time conforming to the definition of “fast-drying”.

As used herein, unless otherwise indicated, the phrase “molecular weight” refers to the weight average molecular weight as measured by gel permeation chromatography (GPC) against a polyacrylic acid (PAA) standard of a copolymer that is hydrolyzed in KOH.

As used herein, the term “pigment volume concentration” or PVC refers to the quantity calculated by the following formula:

$$PVC ( \% ) = \frac{( dry volume of pigment ( s ) + dry volume of extender ( s ) ) \times 100}{total dry volume of paint}$$

Where the total dry volume of paint includes the dry volume of pigments, the dry volume of extenders (e.g., fillers), and the dry volume of binder. For the purpose of this calculation, all polymer solids are considered to be binder and not pigment, including both the film forming and non-film forming portions.

As used herein, the term “road” includes any indoor or outdoor solid surface that is or may be constantly or intermittently traveled on by pedestrians, moving vehicles, tractors, or aircraft continuously. Some non-limiting examples of a “road” include highways, streets, driveways, sidewalks, runways, taxiing areas, tarmac areas, parking lots.

As used herein, unless otherwise indicated, the term “Tg” or “glass transition temperature” of a polymer refers to the Tg of a polymer calculated by using the Fox equation (T. G. Fox, Bull. Am. Physics Soc., Volume 1, Issue No. 3, page 123 (1956). The Tg of various homopolymers may be found, for example, in Polymer Handbook, edited by J. Brandrup and E. H. Immergut, Interscience Publishers. The “Experimental Tg” of a polymer is measured by differential scanning calorimetry (DSC) using the mid-point in the heat flow versus temperature transition as the Tg value. A typical heating rate for the DSC measurement is 20° C./minute.

As used herein, the term “substantially encapsulating” means that greater than 50% of the surface area of the encapsulated particle, e.g. (co)polymer, is covered by the encapsulant, e.g. a non-film forming polymer or a film forming polymer. As used herein, the terms “non-film forming polymer” and “film forming polymer” are used to describe a polymer (e.g., a harder polymer or one with a relatively higher Tg) that provides structure to voided particles and a polymer (e.g., a softer polymer or one with a relatively lower Tg) that allows the particles to function as a binder, respectively.

As used herein, the term “void” refers to a polymer-free space in an interior of a particle, which may be filled with air or another gas when the substance containing it is dry. As used herein, the term “void” is not equivalent to a “pore” which refers to an opening on a surface of a particle.

As used herein, the term “volatile organic compound” (VOC) is defined as a carbon-containing compound that has a boiling point below 280° C. at atmospheric pressure.

As used herein, the phrase “wt. %” stands for weight percent. Unless otherwise specified, all percentages and amounts are with respect to weight.

Hollow core binder particles have one or more hollow core or void and reduce the mass of the particles, thereby reducing the mass of materials used in fast-drying aqueous compositions, such as traffic paints, and allowing applicators to apply more roadway markings with a given mass of paint. Further, hollow core binders contribute to the opacity of dry coating films, thereby allowing for reduction of titanium dioxide or opacifying pigments in coating compositions. Coating compositions comprising the bimodal binder composition of the present invention may provide coatings and films with film integrity and opacity properties comparable to coatings having appreciable amounts of opacifier pigment or TiO₂. Accordingly, coating formulations comprising the inventive bimodal binder composition may provide opacity, brightness and film integrity equal to formulations comprising higher proportions of binder as non-voided polymer particles and higher proportions of opacifiers. Thus, a formulator may achieve a desired level of opacity in coating formulations using the bimodal binder composition of the present invention by using a lower level of pigment and/or extender than would be required to achieve the same level of opacity in a comparable formulation using non-voided polymer particles as binder. Formulations comprising the bimodal binder composition comprise 10 wt % or less of pigments, including TiO₂, preferably 7 wt % or less, more preferably 5 wt % or less, even more preferably 2 wt % or less, and still more preferably 0 wt % pigments relative to the total weight of the paint formulation. As used herein, the term “pigment” is not intended to include calcium carbonate or other fillers with refractive index values below 1.7.

The bimodal binder compositions of the present invention comprise a first mode having binder particles which contain at least one void and a second mode having binder particles which do not contain a void. The particles of the first mode have a larger average particle size than the average particle size of the particles of the second mode.

The particles of the first mode, the second mode, or both, may comprise multistage polymers. Preferably, the first mode particles comprise a multistage polymer. The at least one void of the first mode particles may be formed within a core or in an internal stage of a multistage polymer. The void-containing core or internal stage may be substantially encapsulated by a non-film forming polymer or a subsequent stage of a multistage polymer.

The particles of the first mode have an average particle size ranging from 200 to 650 nm. Preferably, the particles of the first mode have an average particle size of at least 250 nm, more preferably at least 300 nm, and even more preferably at least 350 nm. Preferably, the particles of the first mode have an average particle size of 600 nm or less, and more preferably 550 nm or less.

The ratio of the average particle size of the particles of the second mode to the average particle size of the particles of the first mode may range from 0.1:1 to 0.9:1. Preferably, the ratio of the average particle size of the particles of the second mode to the average particle size of the particles of the first mode is at least 0.2:1, more preferably at least 0.3:1, even more preferably at least 0.4:1, and still more preferably at least 0.4:1. Preferably, average particle size of the particles of the second mode to the average particle size of the particles of the first mode is 0.8:1 or less, more preferably 0.7:1 or less, and even more preferably 0.6:1 or less.

The average particle size of the particles of the second mode may range from 20 nm to 500 nm. Preferably, the average particle size of the particles of the second mode is at least 30 nm, more preferably at least 40 nm, and even more preferably at least 50 nm. Preferably, the average particle size of the particles of the second mode is less than 400 nm, more preferably less than 350 nm, even more preferably less than 300 nm, and still more preferably less than 250 nm.

The particles of the first mode are voided particles comprising at least one void. When dry, the at least one void has an average size ranging from 50 nm to 350 nm, preferably from 100 nm to 300 nm. When the bimodal binder composition of the present invention is used to increase the opacity of coatings or films in which they are present, preferable void sizes range from 200 to 300 nm. If the particles have voids or hollows below of 100 nm, then the hollow core binder particles may fail to exhibit desirable light scattering.

Single void containing polymers formed by multistage emulsion polymerization and methods of making them are known in the art, as disclosed in U.S. Pat. Nos. 4,427,836; 4,469,825; 4,594,363; 4,970,241; 5,225,279; 5,494,971; 5,510,422; 5,527,613; 6,020,435; 6,139,961; 6,673,451; 6,784,262; and 7,645,815; as well as in U.S. Patent Publication Nos. 20010009929A; 20010036990A; and 20030129435A.

One or more hollow or void may be formed in the first mode binder particles by known methods, including swelling, e.g. alkali swelling or alkali hydrolysis and swelling, of the first mode particle, or by dissolving out at least part of or at least part of a core first mode particles to form, when dry, a void, e.g. via the removal of encapsulated fugitive substances or removable porogens therefrom, the use of blowing agents contained therein and activated after polymerization, or the use of solvents to dissolve out portions of a copolymer. Accordingly, the core of a first mode particles may comprise a swellable polymer, such as an alkali swellable polymer, or a solvent soluble polymer, such as polymers soluble in water or in organic solvents. Alternatively, the first mode particle contain a fugitive, porogen or blowing agent substance to form one or more void.

Suitable first mode particles may also contain, when dry, two or more voids, whether isolated or connected to other voids, whether substantially spherical in shape or not, including, for example, void channels, interpenetrating networks of void and polymer, and sponge-like structures, such as are disclosed, for example, in U.S. Pat. Nos. 5,036,109; 5,216,044; 5,521,253 and 5,989,630. Multiple voids may be formed within a core may be fully or partially enclosed by a non-film forming polymer or in an internal stage of a multistage non-film forming polymer.

Swelling is generally very efficient, i.e., swelling in minimum amount of time under conditions of elevated temperature in the presence of monomer and no substantial polymerization occurring. Under these conditions, swelling is generally complete within 30 minutes, preferably within 20 minutes, and most preferably within 10 minutes, of adding the one or more swelling agents. Preferably, suitable amounts of swelling agent range from 75 to 1000%, and, more preferably, from 200 to 960%, based on the equivalents of the functionality in the core of the non-film forming polymer capable of being neutralized by the swelling agent. It is also preferable to add the one or more swelling agents to a multistage emulsion polymer while the multi-stage polymer is at an elevated temperature, preferably at a temperature within 10° C. of the shell polymerization temperature.

In embodiments wherein the particles of the first mode comprise an alkali hydrolysable core or inner stage, e.g. poly(alkyl(meth)acrylate), voids may be formed by exposing the aqueous dispersion of the polymer to a strong alkaline solution, such as sodium hydroxide, at a temperature above room temperature and below 140° C., in an amount of from about 0.75 to about 1.5 equivalents of base, based on all the acids in the shell phases and the more easily hydrolysable acrylate esters in the core or inner stage, such as methyl acrylate.

In another embodiment, the core of the particles of the first mode may be caused to swell by addition of one or more swelling agent to the aqueous dispersion prior to, during, or after the polymerization of the monomers comprising an outer shell stage polymer, and after the formation of an inner shell polymer. As used herein, the phrase “inner shell polymer” refers to a polymer that substantially encapsulates a core or voided inner stage of a multistage polymer, and the phrase “outer shell polymer” refers to the outermost polymer. Preferably, the swelling agent is added to the aqueous dispersion at a time when the aqueous dispersion comprises at least 0.5 wt. %, based on the total weight of the polymer in the dispersion, of unreacted monomer under conditions where there is no substantial polymerization of the monomer, followed by reducing the level of monomer by at least 50%. The phrase “under conditions wherein there is no substantial polymerization of the monomer” and the techniques for achieving such conditions are as described in U.S. Patent Publication No. 20010009929A. Reducing the level of monomer to less than 10,000 ppm, and preferably to less than 5,000 ppm, based on polymer solids, can be accomplished by any suitable means, such as solvent fractionation and, preferably, by polymerizing the monomer, such as, for example, by adding one or more initiators recited above. Preferably, reduction of the level of monomer is begun within 20 minutes, and more preferably within 10 minutes, of adding the one or more swelling agents.

Suitable swelling agents may include those which, in the presence of a core-shell polymer emulsion and monomer(s) used to form an outer shell, are capable of permeating the inner shell and swelling the core. Swelling agents may be aqueous or gaseous, volatile or fixed bases, or combinations thereof. Suitable swelling agents include volatile bases, such as ammonia, ammonium hydroxide, and volatile lower aliphatic amines, such as morpholine, trimethylamine, and triethylamine; fixed or permanent bases, such as potassium hydroxide, lithium hydroxide, zinc ammonium complex, copper ammonium complex, silver ammonium complex, strontium hydroxide, and barium hydroxide. Solvents, such as, for example, ethanol, hexanol, octanol and those described in U.S. Pat. No. 4,594,363, may be added to aid in fixed or permanent base penetration. Ammonia and ammonium hydroxide are preferred.

Suitable removable porogens, may include, for example, titanium dioxide and silicon oxide, which are removable with aqueous acid.

In one embodiment, the core or inner stage comprising the at least one void of the first mode particles of the invention are formed in the presence of at least one fugitive substance, i.e., any substance having a normal boiling point of less than 30° C., as taught in U.S. Pat. No. 6,632,531, and an outer shell polymer of the invention is polymerized in the presence of the voided polymer comprising the core or inner stage. In such embodiments, the outer shell polymer may be formed either before or after the removal of the fugitive substance. Suitable fugitive substances may include, for example supercritical carbon dioxide, oxidizable compounds that leave voids on oxidation, and blowing agents. Preferably, fugitive substances are chosen from supercritical carbon dioxide, C1-C4 alkanes, e.g., butane, 2,2-dimethylpropane, and dimethyl ether. Other fugitive substances may include, for example, C1-C4 haloalkanes, such as C1-C4 chlorofluoroalkanes or C1-C4 perfluoroalkanes, 1,1,1,2-tetrafluoroethane, difluoromethane, sulfur hexafluoride, carbon dioxide, methane, and combinations thereof.

To enable formation of one or more void therein, in one embodiment, the first mode particles may comprise an organic solvent soluble polymer as a core of a multi-stage copolymer, one polymer in an inner stage polymer as an interpenetrated network (IPN), or a copolymerized portion of a single stage polymer. Voids may be formed, for example, by solution polymerizing monomers comprising 5 to 100 wt. %, based on total monomer weight, of one or more hydrophilic mono-ethylenically unsaturated monomer and the remainder of one or more organic solvent soluble ethylenically unsaturated monomer, in a water-immiscible or hydrophobic solvent or solvent mixture, to form a separate inner polymer, a stage of an inner polymer, or one of two or more inner polymers in an IPN, and, subsequently, solution polymerizing hydrophobic (co) monomer or (co) reactant in a separate stage or separate polymer to make an inner polymer or a stage thereof in solution, dispersing the solution comprising the thus formed copolymer or polymer mixture in water in the presence of a base, and distilling to remove the organic solvent down to a concentration of less than 5% by weight, based on the amount of the dispersion, replacing the solvent with water. The outer shell polymer can then be emulsion polymerized in the presence of the resulting aqueous inner polymer dispersion to make the binder particles of the first mode of the present invention. After subsequent drying, the dry dispersion can be re-dispersed in water in the presence of base, e.g. ammonia.

Suitable organic solvent soluble polymers and the solvents in which they dissolve are described, for example, in U.S. Pat. No. 5,989,630 and may comprise, as polymerized units, any nonionic mono-ethylenically unsaturated monomer or diene, such as butadiene. Suitable solvents may comprise toluene; (cyclo) aliphatic hydrocarbons, e.g. n-hexane; or a mixture of a good solvent for the polymer and a very poor solvent (coagulant) for the polymer.

In one embodiment, the binder particles of the first mode comprise a hollow or voided core comprised of one or more non-film forming polymers containing one or more void. Preferably, the non-film forming polymer has a glass transition temperature sufficient to provide in-process durability and being substantially encapsulated by one or more film-forming polymers that may make up an outer stage, wherein the film-forming polymer has a glass transition temperature (Tg) ranging from −30° C. or more, and ranging up to and including 60° C., preferably, −20° C. or more. Preferably, greater than 75%, and more preferably 100%, of the surface area of the non-film forming polymer is covered by the film-forming polymer. To ensure that the film-forming polymer substantially encapsulates the non-film forming polymer and to ensure that the hollow core binder particles behaves as a binder, the weight ratio of film forming polymer to the non-film forming polymer in the binder particles of the first mode of the present invention may range from 1:1 to 4:1. Preferably, the weight ratio of film forming polymer to the non-film forming polymer ranges from 1.5:1 to 3:1. The extent of coverage or encapsulation of the polymeric particles may be determined by scanning electron microscopy, with or without staining techniques, as is known in the art.

In the particles of the first mode, each of the non-film forming polymer and film forming polymer may, independently, comprise a single stage (co)polymer or a multi-stage copolymer having two or more stages. Preferably, the non-film forming polymer comprises a multi-stage copolymer.

When the non-film forming polymer comprises a multi-stage copolymer having a core, the core polymer or stage may comprise, as polymerized units, any one or more (co)polymer in which one or more hollow or void may be formed in the polymer by known methods, such as alkali swelling. Alternatively, the one or more void or hollow in the non-film forming polymer, whether a single stage polymer or a multi-stage (co)polymer, may be formed by known methods, such as the removal of porogens, void-forming dissolution in organic solvent, or by use of blowing agents.

The compositions of the non-film forming polymer and the film forming polymer used to prepare the particles of the first mode may be selected so as to provide good processability so as to enable the formation of fast-drying aqueous compositions that provide coatings and films with desirable opacity and durability. Each of the non-film forming polymer and film forming polymer of the particles of the first mode may, independently, comprise the polymerization product of one or more ethylenically unsaturated monomer, preferably one or more mono-ethylenically unsaturated monomer. Each of the non-film forming polymer and the film forming polymer may be a condensation polymer, such as a polyester, polyurethane, polyamide or alkyd.

Suitable non-film forming polymers and the film forming polymers of the first mode particles may be any (co)polymer wherein the glass transition temperature (Tg) of the non-film forming polymer is 50° C. or more, preferably, 75° C. or more or, more preferably, 90° C. or more, and the Tg of the film forming polymer ranges from −30° C. to 60° C., and is, preferably, −20° C. or more or, more preferably, −10° C. or more. The Tg of the non-film forming polymer can range up to 150° C. The Tg of the film forming polymer preferably ranges up to 50° C., or, more preferably, up to 40° C. The Tg of the non-film forming polymer is greater than the Tg of the film forming polymer. Preferably, the Tg of the non-film forming polymer is at least 20° C., and more preferably at least 30° C. greater than the Tg of the film forming polymer.

One or both of the non-film forming polymer and the film forming polymer may be formed from, as polymerized units, one or more mono-ethylenically unsaturated monomer. Such a polymer may be formed by free radical addition polymerization. The non-film forming polymer may comprise, as polymerized units, 50 wt. % or more of nonionic mono-ethylenically unsaturated monomer and, optionally, at least one copolymerized mono-ethylenically unsaturated monomer. Further, the non-film forming polymer may comprise, as polymerized units, from 0.05 to 50 wt. %, preferably, 0.2 or more wt. %, or, preferably, up to 35 wt. %, more preferably from 0.5 to 25 wt. %, yet more preferably 1 to 5 wt. %, based on the total weight of monomers used to make the polymer, of multi-ethylenically unsaturated monomers. The core stage of the multi-stage non-film forming polymer may optionally contain less than 20 wt. %, and preferably from 0.1 to 3 wt. %, based on the total weight of the core, of multi-ethylenically unsaturated monomer. Alternatively, one or both of the non-film forming polymer and the film forming polymer may be chosen from condensation polymers, for example, polyester, polyurethane, or polyamide. Preferably the non-film forming polymer and the film forming polymer are formed from predominantly (meth)acrylic, styrene/(meth)acrylic, or vinyl acetate/acrylic monomers; more preferably, the non-film forming polymer is formed from monomers chosen from styrene, (meth)acrylic monomers, and mixtures thereof.

In a preferred embodiment, the non-film forming polymer or one or more core stage thereof comprises one or more alkali swellable polymer. An alkali swellable non-film forming polymer may contain, as polymerized units, one or more mono-ethylenically unsaturated acid or diacid, e.g. (meth)acrylic acid, or one or more acid-free polymerized unit that is hydrolyzable and swellable in alkaline environments at temperatures above the polymer Tg, such as for example, (meth)acrylate esters, vinyl esters of carboxylic acids or mixtures thereof. Alkali swellable polymers may also include alkali soluble polymers, i.e. those containing enough acid that they dissolve in alkali. Accordingly, in a preferred embodiment, the core stage of a multi-stage non-film forming polymer comprises, as polymerized units, from 5 to 100 wt. %, based on a weight of the core stage polymer, of one or more hydrophilic mono-ethylenically unsaturated monomer, preferably a monomer comprising alkali swellable acid or diacid groups or alkali hydrolysable functions, and from 0 to 95 wt. %, based on the weight of the core polymer, of at least one nonionic mono-ethylenically unsaturated monomer. Acrylic acid and methacrylic acid are preferred hydrophilic monomers.

The film forming polymer of the first mode binder particles may be any film-forming polymer having a suitable Tg, including, but not limited to, emulsion addition (co)polymers and condensation (co)polymers. Where the film forming polymer is a condensation polymer, it may be grafted onto condensation reactive groups in the non-film forming polymer. Thus, for example, where the non-film forming polymer comprises amine or hydroxyl groups, the film forming polymer may be a urethane polymer, an alkyd or a carboxyl functional polyester; likewise, where the non-film forming polymer comprises acid groups, the film forming polymer may comprise a polyester polyol, a polyurethane polyol, or a hydroxyl functional polyester. Suitable addition polymers useful as the film forming polymer may include, for example, homopolymers, copolymers, terpolymers or tetrapolymers containing, as polymerized units, (meth)acrylates, amine-functional (meth)acrylates, α,β-ethylenically unsaturated (di)acids; vinyl esters, e.g. vinyl acetate and vinyl versatate; styrene; butadiene; vinyl acetate-ethylene; vinyl maleate, and vinyl chloride. Suitable film forming polymers may further contain up to 10 wt. %, for example, up to 7.5 wt. %, and, preferably, 0.1 wt. % or more, or, preferably, up to 5.0 wt. %, as polymerized units, one or more functional monomer, such as, (di)acid monomer, for example, carboxylic acid, carboxylic anhydride, phosphate, sulfate, sulfonate; amine-group containing monomers, and combinations thereof. Preferably, the film forming polymer is formed from monomers chosen from butyl acrylate, ethyl acrylate, ethyl hexyl(meth)acrylate, styrene, styrene-butadiene, (di)acid monomer, amine-group containing monomer, and mixtures thereof.

The film forming polymer may contain from 0% to 5.0 wt. %, and, preferably, 0.1 wt. % or more, or, preferably, up to 3.0 wt. %, as polymerized units, of one or more multi-ethylenically-unsaturated monomer, based on the total weight of monomers used to make the polymer. Maintaining a sufficiently low level of crosslinking helps to ensure that, in the case of emulsion polymers, effective film formation is not compromised.

Suitable mono-ethylenically unsaturated monomers may include nonionic monomers such as, for example, (meth)acrylic ester monomers including, for example, C1 to C30 (cyclo)alkyl(meth)acrylates, such as, for example methyl(meth)acrylate, ethyl methacrylate, butyl(meth)acrylate, 2-ethylhexyl(meth)acrylate, decyl acrylate, lauryl(meth)acrylate, isodecyl(meth)acrylate; (meth)acrylamide, substituted (meth)acrylamides, such as N-alkyl(meth)acrylamides and N,N-dialkyl(meth)acrylamides; ethylene; propylene; styrene and substituted styrenes; butadiene; vinyl esters, such as vinyl acetate and vinyl butyrate; vinyl chloride, vinyl toluene, and vinyl benzophenone; (meth)acrylonitrile; and vinylidene halides, such as, vinylidene chloride. Suitable ionic and hydrophilic mono-ethylenically unsaturated monomers may include, for example, hydroxyalkyl(meth)acrylates; glycidyl(meth)acrylate; mono-ethylenically unsaturated acid monomers; acetoacetoxyethyl(meth)acrylate, acetoacetoxyalkyl(meth)acrylates; amine-group containing monomers, such as vinyl imidazole, 2-(3-oxazolidinyl)ethyl(meth)acrylate and amine-functional(meth)acrylates, such as tert-butylaminoethyl(meth)acrylate, N,N-dimethylaminoethyl(meth)acrylate and N,N-dimethylaminopropyl(meth)acrylate; N-vinyl pyrrolidone; sodium vinyl sulfonate; phosphoethyl(meth)acrylate; acrylamido propane sulfonate; diacetone acrylamide; ethyleneureido-functional monomers; isocyanatoalkyl(meth)acrylate, and allyl acetoacetate.

Suitable mono-ethylenically unsaturated acid or diacid monomers may include, for example, (meth)acrylic acid, itaconic acid, monomethyl itaconate, (meth)acryloxypropionic acid, aconitic acid, fumaric acid, crotonic acid, maleic acid, anhydrides thereof, e.g. maleic anhydride; monomethyl maleate; monoalkyl itaconates; monoalkyl fumarates, e.g. monomethyl fumarate; 2-acrylamido-2-methylpropane sulfonic acid; vinyl sulfonic acid; styrene sulfonic acid; 1-allyloxy-2-hydroxypropane sulfonic acid; alkyl allyl sulfosuccinic acid; sulfoethyl(meth)acrylate; phosphoalkyl(meth)acrylates, such as phosphoethyl(meth)acrylate; phosphodialkyl(meth)acrylates; and allyl phosphate. Preferred acid monomers are (meth)acrylic acid, itaconic acid, fumaric acid and maleic acid.

Suitable multi-ethylenically unsaturated monomers include, for example, those having two or more ethylenically unsaturated bonds, such as, allyl(meth)acrylate, diallyl phthalate, glycol di(meth)acrylates, such as, for example, 1,2-ethyleneglycol di(meth)acrylate, 1,4-butylene glycol di(meth)acrylate, 1,6-hexanediol di(meth)acrylate; and divinyl benzene.

The particles of the second mode do not contain a void. The second mode particles may comprise a single stage (co)polymer or a multi-stage copolymer having two or more stages. Preferably, the second mode particles comprise a multi-stage copolymer. Suitable polymers for the particles of the second mode preferably have a Tg ranging from −30° C. to 60° C., and is, preferably, −20° C. or more, or more preferably, −10° C. or more. The Tg of the film forming polymer preferably ranges up to 50° C., or, more preferably, up to 40° C.

The polymer of the second mode binder particles may be any film forming polymer having a suitable Tg, including, but not limited to, emulsion addition (co)polymers and condensation (co)polymers, as described above for the film forming polymer of the particles of the first mode. The film forming polymer of the particles of the second mode may be the same film forming polymer of the first mode particles, or the film forming polymer of the second mode particle may be different from the film forming polymer of the first mode particles. Preferably, the film forming polymer of the particles of the second mode is the same as the film forming polymer of the particles of the first mode.

Preferably the bimodal binder composition comprising the binder particles of the first mode and the binder particles of the second mode is in the form of an aqueous dispersion. The aqueous dispersion may have a solids content of 30 wt. % or more, and preferably, 40 wt. % or more. The aqueous dispersion may have a solids content of up to 60 wt. %, and preferably, up to 55 wt. %. When used in traffic paint formulations, aqueous bimodal binder compositions with too low a solids content will not dry fast enough in practice; however, such compositions can become difficult to process with too high a solids content in traffic paint formulations. The aqueous phase of the dispersion composition includes water and optionally, one or more water miscible organic solvents, such as, methanol, ethanol, glycols, and glycol ethers.

The bimodal binder composition of the present invention may contain the particles of the first mode and the particles of the second mode in a weight ratio ranging from 10:90 to 90:10, preferably 20:80 to 80:20, more preferably 30:70 to 70:30, and even more preferably from 40:60 to 60:40.

The weight ratio of the film forming polymer in the particles of the first mode to the film forming polymer in the particles of the second mode may range from 10:90 to 90:10, preferably 20:80 to 80:20, more preferably 30:70 to 70:30, and even more preferably from 40:60 to 60:40.

The bimodal binder composition of the present invention may be used in a single-component fast-drying aqueous composition or a two-component fast-drying aqueous composition.

Single-component fast-drying aqueous compositions comprise the bimodal binder composition, one or more polyfunctional amine, and one or more volatile base in an amount sufficient to stabilize the composition by deprotonating the polyfunctional amine, wherein the film forming polymer of the first mode particles and/or the polymer of the second mode particles is chosen from an anionically stabilized emulsion polymer, a polyamine functional emulsion polymer containing pendant amine functionality, a hydrophobic polyamine functional emulsion polymer, a blend of an emulsion polymer having pendant strong cationic groups with an emulsion polymer having pendant weak acid groups, and mixtures thereof. Accordingly, the film forming polymer of the first mode particles and/or the polymer of the second mode particles in single-component aqueous compositions can comprise the polyfunctional amine.

Two-component fast-drying aqueous compositions comprise the bimodal binder composition having first mode particles with a film forming polymer binder, and an absorber component. In two-component fast-drying aqueous compositions, suitable first mode particles may be any having a film forming polymer having a glass transition temperature (Tg) of from −30° C. to 60° C. The second mode particles of the bimodal binder composition may comprise the same polymer as the film-forming polymer of the first mode particles.

Suitable absorbers may include organic absorbers, such as, for example, hollow sphere polymers or void containing polymers; ion exchange resins (IER), preferably crosslinked IERs; sumica gel (a copolymer of sodium methacrylate and/or ammonium methacrylate), inorganic absorbents, such as talc, clay, calcium oxide, Portland cement, and gypsum; molecular sieves, such as zeolites; non-porous carbonaceous materials, such as carbon blacks and pyrolyzed polyacrylonitrile; porous carbonaceous materials, such as activated carbons; and superabsorbent polymers. The average particle size of an absorber may range from 0.05 μm to 5000 μm, preferably, 10 μm or more and, preferably, up to 1500 μm. The proper amount of absorber may depend upon one or more of the type of bimodal binder composition used, water content of the aqueous dispersion, type of absorber, paint application conditions, and other ingredients present in the paint formulation. Suitable amounts of one or more absorber may range from 0.01 wt. % to 90 wt. %, based on the total weight of the coating composition, preferably, 0.1 wt. % or more, or, preferably, up to 70 weight %, or, more preferably, 1 wt. % or more, or up to 30 wt. %.

The bimodal binder composition of the present invention may be formed by various polymerization and swelling techniques known in the art. Thus, the bimodal binder composition of the present invention may be formed by emulsion polymerization.

For example, the first mode particles of the bimodal binder composition may be formed by multi-stage emulsion polymerization to form a core and/or inner shell with the non-film forming polymer, adding to the aqueous emulsion polymerized core-shell copolymer and polymerizing in the presence of the core-shell polymer one or more mono-ethylenically unsaturated monomer to form the film forming polymer, and, further, adding a swelling agent to the aqueous dispersion prior to, during, or after the polymerization of the mono-ethylenically unsaturated monomers of the film forming polymer. The film forming polymer may be formed in the same reaction vessel or kettle as the non-film forming polymer. Alternatively, the film forming polymer may be formed after a period of time in a different reaction vessel or kettle, such as a holding tank or a drain tank.

Alternatively, the particles of the first mode may be prepared by providing a core polymer comprising at least one void, which may be synthesized according to the process disclosed in U.S. Pat. No. 6,020,435. The core may be prepared separately or as part of a one-pot process for producing the particles of the first mode. Monomers for forming a non-film forming polymer on the core may then be combined with the core polymer and polymerized by multi-stage polymerization to form the particles of the first stage of the bimodal binder composition.

The particles of the second mode may be made in the same manner as the particles of the first mode of the bimodal binder composition. For example, the particles of the second mode may be formed by emulsion polymerization, such as multi-stage emulsion polymerization. The second mode particles may be formed using a seed polymer or using a surfactant to initiate growth, as taught for example, in U.S. Pat. Nos. 6,818,697 and 5,726,259, and one or more ethylenically unsaturated polymer, preferably one or more mono-ethylenically unsaturated monomer, may be polymerized on the seed polymer or surfactant-initiated polymer. Preferably, the particles of the second mode are synthesized with the same monomers as the film forming polymer used to synthesize the particles of the first mode.

The particles of the first mode and the particles of the second mode may be prepared in the same reaction vessel or kettle or separately. When the particles of the first and second modes are prepared in the same reaction vessel or kettle, both modes are synthesized during the same process, whether that process is batch, semi-continuous, or continuous. When formed during the same process, the polymerization of the particles of the first mode can be initiated before the formation of the second particles is initiated. For example, a core may be provided or prepared for the particles of the first mode and monomers can be polymerized to form a hard inner shell from a non-film forming polymer. After the monomers of the non-film forming polymer have polymerized, a seed polymer or surfactant may be added to initiate polymer growth for the second mode particles. Additional monomers may be added (e.g., monomers for a second monomer) and polymerized on the core or inner shell of the first mode particles and the seed or surfactant-initiated growth of the second mode particles simultaneously, thereby forming particles of the first and second modes where the outermost portion of the particles for the first and second modes comprise the polymerized product of similar monomers.

Preferably, the particles of the first mode and the particles of the second mode are made in in the same kettle or vessel.

In a preferred embodiment, at least 10 wt. %, preferably 20 wt. %, more preferably 50 wt. %, and, most preferably, 100 wt. % of the total of the film forming polymer of the first mode particles and/or the polymer of the second mode polymers is formed by polymerization at a temperature of from 5° C. to 65° C., preferably 10° C. to 50° C., more preferably 20° C. to 40° C., wherein the polymerization temperature is at least 30° C. lower than the Tg of the non-film forming polymer of the particles of the first mode. In this embodiment, the temperature at which the film forming polymer is formed may be allowed to rise above 65° C. during the formation of the film forming polymer with the proviso that at least 10% of the film forming polymer is formed at a temperature of from 5° C. to 65° C., wherein the polymerization temperature is at least 30° C. lower than the Tg of the non-film forming polymer.

The concentration of unpolymerized monomer in the reaction vessel is, at any time (T), preferably no greater than 6%, more preferably, no greater than 5%, and even more preferably, no greater than 4%, by weight, based on the total weight of reaction mixture present in the reaction vessel at time (T).

Each of the non-film forming polymer and the film forming polymer may be prepared such that surfactants, initiators, and other additives are selected independently, i.e. they may be the same or different in kind and amount for each polymer. In any emulsion polymerization process, conventional surfactants may be used, including anionic emulsifiers, such as, for example, alkali metal or ammonium salts of alkyl, aryl, or alkylaryl sulfates, sulfonates or phosphates, e.g. sodium lauryl sulfate, sodium polyoxyethylene lauryl ether sulfate, sodium salt of tert-octylphenoxyethoxypoly(39)ethoxyethyl sulfate, sodium dodecyl benzene sulfonate, sodium dodecyl diphenyloxide disulfonate, other diphenylsulfonate derivatives, alkyl sulfonic acids, sulfosuccinic acids and salts, e.g. dioctylsulfosuccinates, fatty acids and their salts; nonionic surfactants, such as, for example, ethoxylated alcohols or phenols and ethylenically unsaturated surfactant monomers; amphoteric surfactants, or mixtures thereof. The amount of surfactant used may range from 0 to 6 wt. %, preferably from 0.1 to 3 wt. %, based on the weight of monomer used to form any polymer.

The non-film forming polymer and the film forming polymer may, independently, be polymerized via free radical polymerization, including, for example, thermal, redox (using redox catalysts), photochemical, and electrochemical initiation. During the interval in which the polymerization reaction temperature is maintained at from 5° C. to 65° C. during the formation of at least 10% by weight of the film forming polymer, a redox polymerization process is preferred.

Suitable free radical initiators or oxidants may include, for example, persulfates, such as, for example, ammonium and/or alkali metal persulfates; peroxides, such as, for example, sodium or potassium hydroperoxide, t-alkyl peroxides, t-alkyl hydroperoxides, dicumyl hydroperoxide; or t-alkyl peresters, wherein the t-alkylgroup includes at least 5 carbon atoms; perboric acids and their salts, such as, for example, sodium perborate; perphosphoric acids and salts thereof; potassium permanganate; and ammonium or alkali metal salts of peroxydisulfuric acid. Such initiators may be used in amounts ranging from 0.01 wt. % to 3.0 wt. %, based on the total weight of monomers.

Suitable redox catalysts comprise one or more oxidant with a suitable reductant. Suitable reductants may include, for example, sodium sulfoxylate formaldehyde; (iso)ascorbic acid; alkali metal and ammonium salts of sulfur-containing acids, such as sodium (bi)sulfite, thiosulfate, hydrosulfite, (hydro)sulfide or dithionite; formadinesulfinic acid; hydroxymethanesulfonic acid; sodium 2-hydroxy-2-sulfinatoacetic acid; acetone bisulfite; amines, such as ethanolamine, glycolic acid; glyoxylic acid hydrate; lactic acid; glyceric acid, malic acid; tartaric acid; and salts of thereof may be used in amounts of 0.01 wt. % to 5.0 wt. %, based on the total weight of monomers.

Redox reaction catalyzing metal salts of iron, copper, manganese, silver, platinum, vanadium, nickel, chromium, palladium, or cobalt may be added for the formation of the non-film forming polymer and the film forming polymer. Typical levels of catalytic metal salts used in accordance with the invention range from 0.01 ppm to 25 ppm, and may range up to 1.0 wt. %, based on the total weight of monomers. Mixtures of two or more catalytic metal salts may also be usefully employed. Chelating ligands, which can be used with catalytic metal salts, include multidentate aminocarboxylate ligands, such as, for example, nitrilotriacetic acid (NTA, a tetradentate ligand), ethylene diamine diacetic acid (EDDA, a tetradentate ligand), N-(hydroxyethyl)ethylene diamine triacetic acid (HEDTA, a pentadentate ligand), and ethylene diamine tetraacetic acid (EDTA, a hexadentate ligand).

Chain transfer agents, such as, for example, mercaptans, such as alkyl thioglycolates, alkyl mercaptoalkanoates, and C4-C22 linear or branched alkyl mercaptans; halogen compounds, including tetrabromomethane; or mercaptocarboxylic acids may be used to control the molecular weight of the non-film forming polymer and film forming polymer. Chain transfer agent(s) may be added in one or more additions or continuously, linearly or not, over most or all of the entire reaction period or during limited portion(s) of the reaction period. Suitable amounts of chain transfer agents range from 0 to 10 wt. %, preferably from 0.1 to 5 wt. %, more preferably 0.25 to 2 wt. %, based on the total weight of monomers.

Any monomer in any polymerization may be added neat, i.e. not as an emulsion in water, or as an emulsion in water. The monomer may be added in one or more additions or continuously, linearly or not, over the reaction period, or combinations thereof. In the case of polyesters or polyamides, the reactant polyacid and polyol, or polyamines, may be polymerized in bulk in the presence of known condensation catalysts, such as trialkyl tin oxides.

The non-film forming polymer and the film forming polymer may, independently, comprise single stage polymers, i.e. made by single stage polymerization, or they may include more than one phase, such as, for example, those formed by a multistage emulsion polymerization. Preferably, the non-film forming polymer is formed by multistage polymerization.

Multistage emulsion polymerization can result in the formation of at least two mutually incompatible polymer compositions, and, thereby, in the formation of at least two phases within the polymer particles. Such particles are composed of two or more phases of various geometries such as, for example, core/shell or core/sheath particles, core/shell particles with shell phases partially encapsulating the core, core/shell particles with a multiplicity of cores, and interpenetrating network particles. Multistage emulsion copolymers can be formed in two or more stages, where the stages differ in molecular weight as well as composition. For example, the core and shell of a preferred non-film forming polymer may themselves be comprised of more than one stage. There may also be one or more intermediate stage. Preferably, the multi-stage polymer comprises a core, an intermediate layer and a shell. The intermediate layer is described in U.S. Patent Publication No. 2001/0009929A.

In a preferred embodiment, the bimodal binder composition of the present invention is formed by methods comprising providing an aqueous dispersion of multi-stage emulsion polymer comprising a core stage polymer (the “core”) and a first shell stage polymer (the “first shell”), adding a seed polymer, and then adding to the emulsion of multi-staged polymer and seed polymer at least one mono-ethylenically unsaturated monomer and causing the monomer to polymerize in the presence of the multi-staged polymer and seed polymer to simultaneously form a second shell stage polymer (the “second shell”) to substantially encapsulate the first shell stage polymer, thus forming the particles of the first mode, and to substantially encapsulate the seed polymer, thus forming the particles of the second mode. Preferably, the polymerization temperature is at least 30° C. lower than the calculated Tg of the first shell stage polymer. The core of the multi-stage emulsion polymer is caused to swell by the addition of a swelling agent to the aqueous dispersion prior to, during, or after the polymerization of the monomers comprising the second shell stage polymer. This preferred process is as described in U.S. Patent Publication No. 2001/0009929A.

In a multi-stage first mode particle, the non-film forming polymer or a core stage of has an average particle size diameter of from 50 nm to 250 nm, and preferably, from 50 nm to 200 nm, in an unswollen condition. If the core is obtained from a seed polymer, such as one described in US Publication No. 2001/0009929, the seed polymer, preferably, has an average particle size of from 30 nm to 150 nm.

In formulating fast-drying aqueous binder compositions, the volatile base is added to the aqueous bimodal binder composition before any polyfunctional amine, if used, to insure stability. Preferably, the volatile base is combined with the aqueous hollow core binder as soon as is practicable after polymerization. Because they may be corrosive, fast-drying binder compositions should be formulated in glass, glass lined or non-ferrous metal containers, such as stainless steel.

In single-component fast-drying aqueous binder compositions, the type and amount of volatile base used may be sufficient to raise the pH of the fast-drying aqueous dispersion composition to the point where a desired proportion of the polyfunctional amine is in a non-ionic state (deprotonated). In the non-ionic state (i.e. deprotonated), polyfunctional amine interaction with the anionically stabilized emulsion and any other anionic ingredients which may be present in the composition is minimized. The volatile base must be volatile enough to be released under air drying conditions. During film formation, the volatile base evaporates with the result that the amine moieties of the polyamine functional polymer become protonated to form ammonium moieties which, in turn, interact with the anionic ingredients to destabilize the coating composition and thereby accelerate drying. Suitably, from 20 to 100 mole % of the amino groups of the polyfunctional amines may be deprotonated, preferably from 60 to 100 mole %, more preferably from 80 to 100 mole %, and most preferably from 90 to 100 mole %. Accordingly, suitable pH ranges for fast-drying aqueous dispersions may range from 7.5 to 11, preferably 9 or higher, more preferably, from 9.5 to 10.7. Suitable amounts of a volatile base may range from 0.2 to 5 wt. %, based on the total weight of aqueous dispersion of the bimodal binder composition, the polyfunctional amine, and the volatile base. Suitable volatile bases may include any of ammonia, C1-C6 alkyl amines and C1-C6 alkanolamines, such as, for example, butylamine, propylamine, ethylamine, ethylenediamine, trimethyl amine, triethyl amine, diethylamine, diethanolamine, ethanolamine, 2-methylaminoethanol, 2-dimethylaminoethanol, morpholine, and N-methylmorpholine. Preferably, the volatile base is ammonia, or an admixture thereof with other volatile or nonvolatile bases.

Polyfunctional amines, as defined herein, comprise amine-functional polymers having a weight average molecular weight of 1,000 or more. Polyfunctional amines may include, for example, polymers formed from either an amine-group containing monomer or an imine monomer, for example from 20 to 100 wt. % of such a monomer as polymerized units. Examples of the amine containing monomers include aminoalkyl vinyl ether or sulfides; acrylamide or acrylic esters, such as dimethylaminoethyl(meth)acrylate; N-(meth)acryloxyalkyl-oxazolidines such as poly(oxazolidinylethyl methacrylate), N-(meth)acryloxyalkyltetrahydro-1,3-oxazines, and monomers that readily generate amines by hydrolysis, as disclosed in U.S. Pat. No. 5,804,627. Polymers prepared using imine monomers contain no imine functionality and, instead, contain amine functionality as part of the polymer backbone. Suitable polyfunctional amines may include, for example, poly(oxazolidinylethyl methacrylate), poly(vinylamine), polyalkyleneimine, e.g. poly(ethyleneimine), and aqueous hollow core binder dispersions comprising as a film forming polymer a polymer containing pendant amine groups or strong cationic groups. U.S. Pat. No. 5,672,379 discloses additional polyfunctional amines.

Suitable amounts of the polyfunctional amine may range from 0 to 10 wt. %, preferably from 0.1 to 8 wt. %, based on the total weight of the aqueous dispersion of the bimodal binder composition, the polyfunctional amine, and the volatile base, preferably 0.2 wt. % or more, or, preferably, 5.0 wt. % or less, and, more preferably, 0.5 wt. % or more or, more preferably, 2.0 wt. % or less. The polyfunctional amine may, alternatively, be present in the coating composition, or it may be added as a separate component before, during or after the dispersion composition is applied.

Coating and traffic paint formulations may contain additional formulation ingredients, such as, for example, thickeners, such as polyvinyl alcohol (PVA), hydroxyethyl cellulose (HEC), alkali-soluble or alkali-swellable emulsions (ASE), cellulosic thickeners, fumed silica, and attapulgite clay; rheology modifiers; pigments, such as titanium dioxide, organic pigments, and carbon black; extenders such as calcium carbonate, talc, clay, silicas, and silicates; fillers, such as glass or polymeric microspheres, quartz(ite) and sand; colorants; plasticizers; crosslinking agents; adhesion promoters, such as silanes; tackifiers; coalescents, for example, alkylene glycols; 2,2,4-trimethyl-1,3-pentanediol monoisobutyrate, glycol ethers; dispersants; wetting agents; surfactants; dyes; sequestering agents; preservatives; biocides; anti-freeze agents; slip additives; waxes; freeze/thaw protectors; defoamers; corrosion inhibitors; and anti-flocculants.

Thickeners may include any material added to a coating to modify its rheological profile. Preferably, thickeners comprise associative thickeners, such as, for example, hydrophobically-modified, alkali soluble emulsions (HASE), hydrophobically-modified ethylene oxide-urethane polymers (HEUR), and hydrophobically-modified hydroxy ethyl cellulose (HMHEC).

Suitable dispersants may include non-ionic, anionic, and cationic dispersants, such as, for example, 2-amino 2-methyl 1-propanol (AMP), dimethyl amino ethanol (DMAE), potassium tripolyphosphate (KTPP), trisodium polyphosphate (TSPP), citric acid and other carboxylic acids; anionic polymers such as homopolymers and copolymers based on polycarboxylic acids, including those that have been hydrophobically- or hydrophilically-modified, e.g. poly(meth)acrylic acid with various comonomers such as styrene, or alkyl(aryl)(meth)acrylate esters, salts of the aforementioned polymers, as well as mixtures thereof.

One or more surfactant may be used to stabilize the emulsion polymerization systems before, during, and after polymerization of monomers and may be present at levels of from 0 to 6 wt. %, preferably from 0.1 to 3 wt. %, based on the total weight of monomer in polymerization. Suitable surfactants include cationic, anionic, and non-ionic surfactants. Anionically stabilized emulsion polymers may be stabilized by anionic surfactant or a mixture thereof with one on more nonionic surfactant.

Suitable defoamers may include silicone-based and mineral oil-based defoamers, and the like. Suitable biocides and mildewcides may include zinc oxide, isothiazolones, triazoles, and benzotriazoles.

The formulated coating compositions or traffic paints may have a PVC of 70% or less, preferably 62% or less, and preferably, 50% or more.

Methods of producing coatings, such as roadway markings on a road surface, may comprise applying onto the substrate or road surface one or more layer of the fast-drying aqueous composition and evaporating the volatile base therefrom to provide the traffic marking on the road surface and/or allowing the absorber component to absorb aqueous liquid. Accordingly, methods of forming coatings may comprise applying an aqueous bimodal binder composition to a substrate and, separately, applying one or more absorber component to the substrate simultaneously with, before, or after the step of application of the aqueous bimodal binder composition while it is still wet or fluid. The fast-drying aqueous composition can be applied by any method known in the art. Whether it comprises one layer or more than one layer, a suitable thickness of the dried film generally ranges from 100 μm to 900 μm, preferably 200 μm or more, and preferably, up to 600 μm, and more preferably up to 450 μm.

To improve the visibility of the roadway markings, application methods may include applying glass beads on the layer of the traffic paint or coating while the layer is still wet to ensure the adhesion of the glass beads to the traffic paint layer or premixing them into the traffic paint prior to application. The glass beads may be applied by known methods, such as, for example, by spraying the glass beads entrained in and conveyed by a jet of air atop the traffic paint layer, or by sprinkling the glass beads from a storage hopper positioned above the applied traffic paint. The amount of glass beads applied on the coating layer may range from 250-600 grams per square meter of the coating layer for visibility at night. Suitable glass beads specified for roadway markings may have an average particle size ranging from 50 to 1800 μm, preferably 200 μm or more and up to 1200 μm.

The compositions are suitable for coating or forming films on substrates such, as, for example, roads, and traffic control devices such as guardrails and concrete barriers, roof tops, walls, for example, in exterior insulation finishing systems (EIFS), walkways, runways, parking areas, and indoor floors (such as in factories or shopping malls). Typical substrates include, for example, masonry, tar, asphalt, resin, concrete, cement, stone, stucco, tile, polymeric materials, metals, such as aluminum, stainless steel, or carbon steel, and combinations thereof. All of the substrates may already have one or more layers of an existing coating or paint which may be fresh or aged.

### EXAMPLES

The following examples illustrate the present invention. In the examples, the following test methods have been used:

Viscosity: A Brookfield KU-1+ Viscometer was used to measure the viscosity of the aqueous coating compositions. After attaching a metal spindle, the viscometer arm was lowered until the spindle was submerged in the coating to the indicated line. The KU viscometer was activated and the viscosity (KU) was recorded. Following formulation, the aqueous coating compositions were poured in to a 0.24 liter (½ pint) metal container, and viscosity was measured. A viscosity of 80-90 KU for the formulated paint is preferable.

Dry-To-No-Pick-Up: The aqueous coating compositions were drawn down on glass panels charts measuring 12″×4″ using a 0.64 mm (25 mil) opening film caster in a room kept at 23° C. (73.5° F.)+/−2.0° C. and 50+/−10% relative humidity and measuring 23.2° C. (74.2° F.) and 40% RH at the time of testing. A timer was started at the time of paint application, and the glass panel was allowed to dry undisturbed (when not being actively tested) on a benchtop. The painted panel was lightly touched with a gloved finger (Kimtech Purple Nitrile) every 30 seconds beginning 90 seconds after application. Once no paint transferred from the coated panel to the gloved finger, testing began for Dry-to-No-Pick-Up Time (every 60 seconds) using the testing wheel described in ASTM D711. The wheel was cleaned with Acetone and a Kimwipe in between test replicates. The time at which the wheel was able to pass over the coated panel without wet paint being transferred to the wheel was recorded. Lower no-pick-up time is better, preferably less than 10 minutes under these conditions.

CIELAB Color Space L*: The aqueous coating compositions were drawn down on opacity charts (Form 3B, The Leneta Company, Inc.) using a 0.20 mm (8 mil) opening film caster. The charts were air dried in a horizontal position overnight in a room kept at 23° C. (73.5° F.)+/−2.0° C. and 50+/−10% relative humidity. A spectro2go spectrophotometer (BYK-Gardner GmbH) with a d: 8° geometry was used to measure the L* component of CIELAB color over the black Leneta section of the opacity chart. Higher L* is better, preferably above 85.

CIE Y Reflectance: The aqueous coating compositions were drawn down on opacity charts (Form 3B, The Leneta Company, Inc.) using a 0.20 mm (8 mil) opening film caster. The charts were air dried in a horizontal position overnight in a room kept at 23° C. (73.5° F.)+/−2.0° C. and 50+/−10% relative humidity. A SpectroGuide Sphere spectrophotometer (BYK-Gardner GmbH) was used to measure the Y component of light reflectance of the XYZ color scale over the black Leneta section of the opacity chart.

Freeze Thaw Stability: The aqueous coating compositions were poured in to a 0.47 liter (1 pint) metal container. Prior to beginning the freeze thaw stability test, the coating sample was gently stirred with a tongue depressor and KU viscosity was measured. The coating container was then sealed and placed in a freezer (measured average temperature of −13.0° C. (8.6° F.)) overnight. Following an overnight freeze of roughly 16 hours, the coatings were allowed to thaw at ambient conditions for a minimum of 6-8 hours. The coatings were gently stirred with a tongue depressor and KU viscosity was measured. The change in viscosity (AKU) was determined by subtracting viscosity from the original KU prior to beginning freeze thaw. This freeze/thaw process was repeated up to 4 times for passing samples, and the number of cycles to KU rise >10 was recorded. A higher number of cycles is better, preferably above 4 cycles.

### Polymer Core:

In Comparative Binders 2 and 3 and in Inventive Binders 1 to 4 below, the polymer core used in the preparation of the hollow core binder comprised a 66 MMA/34 MAA wt. % polymer core prepared via aqueous emulsion polymerization according to U.S. Pat. No. 6,020,435. The polymerization product was filtered to yield a filtered dispersion. The filtered polymer core dispersion had a solids content of 32.0 wt. % and an average particle size of 135 nm.

### Comparative Binder 1:

A 5-liter, four necked round bottom flask was equipped a paddle stirrer, thermometer, N₂ inlet and reflux condenser. DI water (462.2 g), Polystep B-5-N emulsifier (6.76 g), and aqueous ammonium hydroxide (6.76 g, 28% in water) was added to the kettle and heated to 79° C. under N₂. When the kettle was at 79° C., 87.93 g of monomer emulsion 1 (ME 1), which was prepared by mixing DI water (417.67 g), Polystep B-5-N emulsifier (28.18 g), butyl acrylate (885.28 g), methyl methacrylate (897.96 g), methacrylic acid (23.39 g), and 1-dodecanethiol (22.6 g) was then added to the kettle followed by a solution of ammonium persulfate (APS, 4.68 g in 16.91 g water). The reaction was allowed to exotherm to its peak without additional heating or cooling applied to the kettle. Upon reaching peak exotherm, ME 1 and co-feeds including a solution of APS (6.31 g in 93.57 g water) and a solution of aqueous ammonium hydroxide (11.61 g, 28% in water combined with 89.06 g water) were added to the kettle over a period of 90 minutes while maintaining 88° C. Upon completion of feeds, 389.49 g of water was added to the kettle and the kettle was cooled to 80° C.

While cooling the kettle to 80° C., an aqueous mixture of ferrous sulfate, isoascorbic acid (IAA), and ethylenediamine tetraacetic acid tetrasodium salt (EDTA) (0.45 g, 0.15 wt. % FeSO₄, 0.08 g IAA, and 0.7 g, 1 wt. % EDTA in 5.11 g water) was added to the kettle followed by a solution of t-butylhydroperoxide (t-BHP, 0.15 g in 5.64 g water). When the kettle temperature reached 80° C., a solution of ferrous sulfate and EDTA (3.38 g, 0.15% wt. % FeSO₄ and 0.51 g, 1 wt. % EDTA in 2.82 g water) was added to the kettle. Co-feeds including a solution of t-butylhydroperoxide (t-BHP 1.32 g in 26.94 g water) and a separate solution of isoascorbic acid (IAA, 0.7 g in 32.58 g water) were both added simultaneously to the kettle over 40 minutes. Upon completion of the co-feeds, the kettle was cooled to 55° C.

At 55° C., NH₄OH (87.93 g, 28 wt. % aq.) mixed with DI water (20.54 g) was added to the kettle over 10 minutes. When NH₄OH addition was complete, the kettle was cooled to 40° C. While cooling, 85.68 g of a polyamine solution prepared as described in U.S. Pat. No. 5,672,379 in 18.79 g water was added to the kettle over 10 minutes. Upon completion of addition of the polyamine solution, the dispersion was filtered to remove any coagulum. The filtered acrylic dispersion had a solids content of 50.1%.

### Comparative Binder 2:

A 5-liter, four necked round bottom flask was equipped a paddle stirrer, thermometer, N₂ inlet and reflux condenser. DI water (500 g) was added to the kettle and heated to 87° C. under N₂. Sodium persulfate (NaPS, 1.90 g in 30 g water) was added to vessel immediately followed by Core #1 (125 g). Monomer emulsion 1 (ME 1), which was prepared by mixing DI water (125 g), Disponil FES-32 emulsifier (10.0 g), styrene (436.8 g), acrylonitrile (112 g), linseed oil fatty acid (2.8 g), and divinylbenzene (80%, 7 g), was then added to the kettle over 90 minutes while maintaining a constant temperature range of 77-79° C. 2 minutes after start of ME 1 feed, 5.6 g of acrylic acid in 35 g water was added to the kettle. 40 minutes after start of ME 1 feed, a solution of sodium persulfate (0.5 g in 30 g water) was fed to the kettle over 45 minutes and temperature was allowed to increase to 84° C. 55 minutes after start of ME 1 feed, temperature was allowed to increase to 92° C. Upon completion of ME 1, the batch was cooled to 72° C.

When the kettle temperature reached 80° C., an aqueous mixture of ferrous sulfate and EDTA (13.3 g, 0.15 wt. % FeSO₄, and 2 g, 1 wt. % EDTA) was added to the kettle. When the kettle temperature reached 72° C., co-feeds including a solution of t-butylhydroperoxide (t-BHP 1.9 g) and NaPS (5.0 g) mixed with DI water (100 g), along with a separate solution of isoascorbic acid (IAA, 2.6 g in 100 g water) were both added simultaneously to the kettle at 1.2 g/mins. Two min after the start of charging the co-feed solutions, ME 2, which was prepared by mixing DI water (240 g), Disponil FES-32 emulsifier (17.0 g), butyl acrylate (591.6 g), methyl methacrylate (416.4 g), and methacrylic acid (12.0 g), was added to the kettle over 55 min while allowing the temperature to rise to 80° C. without providing any external heat. Upon completion of ME 2 addition, the co-feed solutions were stopped and the batch was held for 5 min at 80° C. A solution of NH₄OH (5 g, 28 wt. % aq.) mixed with DI water (5.0 g) was then added to the kettle along with hot (90° C.) DI water (225 g).

ME 3, which was prepared by mixing DI water (54.0 g), Disponil FES-32 emulsifier (3.0 g), butyl acrylate (104.4 g), methyl methacrylate (75.6 g), and 4-hydroxy TEMPO (3 g, 5 wt. % aq.), was fed to the kettle over 5 min. Immediately after the ME 3 feed addition was complete, NH₄OH (35.0 g, 28 wt. % aq.) mixed with DI water (40 g) was added to the kettle over 2 min. When NH₄OH addition was complete, the batch was held for 5 min. The addition the co-feed solutions was resumed at 1.2 g/min until completion, whereupon the dispersion was cooled to 25° C. While cooling, additional co-feeds including a solution of t-BHP (1.5 g) in DI water (25 g), along with a separate solution of IAA (0.7 g) in water (25 g) were both added simultaneously to the kettle at a rate of 1.30 g/min. Upon completion of addition of the second co-feed, 59.0 g of Disponil FES-993 emulsifier was added to the kettle followed by 66.0 g of a polyamine solution prepared as described in U.S. Pat. No. 5,672,379. A solution of Acrysol ASE-60 (13.35 g in 53 g water) was then added to the kettle over a period of 10 minutes. The dispersion was filtered to remove any coagulum. The filtered opaque acrylic dispersion (OAP) had a solids content of 47.9%. The S/mil was measured to be 1.31.

### Comparative Binder 3:

A 5-liter, four necked round bottom flask was equipped a paddle stirrer, thermometer, N₂ inlet and reflux condenser. DI water (462 g) was added to the kettle and heated to 89° C. under N₂. Sodium persulfate (NaPS, 2.60 g in 20 g water) was added to vessel immediately followed by Core #1 (171 g). Monomer emulsion 1 (ME 1), which was prepared by mixing DI water (55.0 g), Polystep A-16-22 emulsifier (3.7 g), styrene (55.0 g), methacrylic acid (6.6 g), and methyl methacrylate (48.4 g), was then added to the kettle over 60 min at a constant temperature range of 77-79° C. Upon completion of ME 1, a second monomer emulsion (ME 2), which was prepared by mixing DI water (220 g), Polystep A-16-22 emulsifier (9.9 g), styrene (643.5 g), linseed oil fatty acid (3.3 g), and divinylbenzene (80%, 8.3 g), was then added to the kettle over 63 minutes and a solution of sodium persulfate (NaPS, 0.7 g in 40 g water) was added to the kettle over 58 minutes while allowing temperature to increase to 84° C. 15 minutes after start of ME 2 feed, temperature was allowed to increase to 92° C. Upon completion of ME 2, the batch was cooled to 60° C.

When the kettle temperature reached 60° C., an aqueous mixture of ferrous sulfate and EDTA (13.5 g, 0.15 wt. % FeSO₄, and 2.1 g, 1 wt. % EDTA) was added to the kettle. Co-feeds including a solution of t-butylhydroperoxide (t-BHP 2.6 g in 70 g water), along with a separate solution of isoascorbic acid (IAA, 1.8 g in 70 g water) were both added simultaneously to the kettle at 0.8 g/mins. Two min after the start of charging the co-feed solutions, ME 3, which was prepared by mixing DI water (210 g), Disponil FES-32 emulsifier (11.7 g), butyl acrylate (330 g), methyl methacrylate (288 g), and acrylic acid (9.3 g), was added to the kettle over 55 min while maintaining temperature at 60° C. Upon completion of ME 3 addition, the co-feed solutions were stopped and the batch was held for 5 min at 60° C. A solution of NH₄OH (5 g, 28 wt. % aq.) mixed with DI water (5.0 g) was then added to the kettle along with hot (90° C.) DI water (700 g).

ME 4, which was prepared by mixing DI water (37.0 g), Polystep A-16-22 emulsifier (2.1 g), butyl acrylate (72 g), methyl methacrylate (52 g), and 4-hydroxy TEMPO (2.5 g, 5 wt. % aq.), was fed to the kettle over 5 min. Immediately after the ME 4 feed addition was complete, NH₄OH (40.0 g, 28 wt. % aq.) mixed with DI water (40 g) was added to the kettle over 2 min. When NH₄OH addition was complete, the batch was held for 5 min. The addition the co-feed solutions was resumed at 0.8 g/min until completion, whereupon the dispersion was cooled to 25° C. While cooling, additional co-feeds including a solution of t-BHP (1.0 g) in DI water (25 g), along with a separate solution of IAA (0.5 g) in water (25 g) were both added simultaneously to the kettle at a rate of 0.85 g/min. Upon completion of addition of the second co-feed, 51.0 g of Disponil FES-993 emulsifier was added to the kettle followed by 70.5 g of a polyamine solution prepared as described in U.S. Pat. No. 5,672,379. The dispersion was filtered to remove any coagulum. The filtered opaque acrylic dispersion (OAP) had a solids content of 39.6%. The S/mil was measured to be 0.65.

### Inventive Binder 1:

A 5-liter, four necked round bottom flask was equipped a paddle stirrer, thermometer, N₂ inlet and reflux condenser. DI water (725 g) was added to the kettle and heated to 87° C. under N₂. Sodium persulfate (NaPS, 1.9 g in 20 g water) was added to vessel immediately followed by Core #1 (124.5 g). Monomer emulsion 1 (ME 1), which was prepared by mixing DI water (125 g), Disponil FES-32 emulsifier (10 g), styrene (436.8 g), acrylonitrile (112 g), linseed oil fatty acid (2.8 g), and divinylbenzene (80%, 7.0 g), was then added to the kettle over 60 min. The temperature of the reaction mixture was allowed to increase to 92° C. after 15 min. 2 minutes after the start of ME 1 addition, a solution of acrylic acid (5.6 g) in DI water (50 g) was added to the flask. 15 minutes after the start of ME 1 addition, 21.45 g of a separately prepared polymer (33% solids, 45 nm weighted average particle size) comprised of ethyl acrylate and methyl methacrylate was added to the kettle and a solution of 0.5 g NaPS in 30 g water was added to the kettle over 45 minutes. Upon completion of the ME 1 feed, the reaction was cooled to 60° C.

When the kettle temperature reached 60° C., an aqueous mixture of ferrous sulfate and EDTA (13.3 g, 0.15 wt. % FeSO₄, and 2 g, 1 wt. % EDTA) was added to the kettle. Co-feeds including a solution of t-butylhydroperoxide (t-BHP 1.9 g) and NaPS (5.0 g) mixed with DI water (100 g), along with a separate solution of isoascorbic acid (IAA, 2.6 g) in DI water (100 g) were both added simultaneously to the kettle over 77 minutes. Two min after the start of charging the co-feed solutions, ME 2, which was prepared by mixing DI water (240 g), Disponil FES-32 emulsifier (17.0 g), butyl acrylate (540.6 g), methyl methacrylate (471.8 g), and acrylic acid (15.3 g), was added to the kettle over 55 min while allowing the temperature to rise to 85° C. without providing any external heat. Upon completion of ME 2 addition, the co-feed solutions were stopped and the batch was held for 5 min at 85° C.

Upon completion of the hold, ME 3, which was prepared by mixing DI water (54.0 g), Disponil FES-32 emulsifier (3 g), butyl acrylate (97 g), methyl methacrylate (83 g), and 4-hydroxy TEMPO (3 g, 5 wt. % aq.), was fed to the kettle over 5 min. Immediately after the ME 3 feed addition was complete, NH₄OH (50.0 g, 28 wt. % aq.) mixed with DI water (40 g) was added to the kettle over 2 min. When NH₄OH addition was complete, the batch was held for 5 min. The addition the co-feed solutions was resumed until completion, whereupon the dispersion was cooled to 25° C. While cooling, additional co-feeds including a solution of t-BHP (1.5 g) in DI water (25 g), along with a separate solution of IAA (0.7 g) in water (25 g) were both added simultaneously to the kettle over 30 minutes. Upon completion of addition of the second co-feed, 59.0 g of Disponil FES-993 emulsifier was added to the kettle followed by 66.0 g of a polyamine solution prepared as described in U.S. Pat. No. 5,672,379. A solution of Acrysol ASE-60 (13.35 g in 53 g water) was then added to the kettle over a period of 10 minutes. The dispersion was filtered to remove any coagulum. The filtered opaque acrylic dispersion (OAP) had a solids content of 48.0%. The S/mil was measured to be 1.01.

### Inventive Binder 2:

A 5-liter, four necked round bottom flask was equipped a paddle stirrer, thermometer, N₂ inlet and reflux condenser. DI water (480 g) was added to the kettle and heated to 89° C. under N₂. Sodium persulfate (NaPS, 2.5 g in 25 g water) was added to vessel immediately followed by Core #1 (125 g). Monomer emulsion 1 (ME 1), which was prepared by mixing DI water (100 g), Disponil FES-32 emulsifier (10 g), styrene (436.8 g), acrylonitrile (112 g), linseed oil fatty acid (2.8 g), and divinylbenzene (80%, 7.0 g), was then added to the kettle over 60 min. The temperature of the reaction mixture was allowed to increase to 90° C. after 30 min. 2 minutes after the start of ME 1 addition, a solution of acrylic acid (5.6 g) in DI water (25 g) was added to the flask. 15 minutes after the start of ME 1 addition, 21.45 g of a separately prepared polymer (33% solids, 45 nm weighted average particle size) comprised of ethyl acrylate and methyl methacrylate was added to the kettle. Upon completion of the ME 1 feed, the reaction was cooled to 60° C.

When the kettle temperature reached 80° C., an aqueous mixture of ferrous sulfate and EDTA (20 g, 0.1 wt. % FeSO₄, and 2 g, 1 wt. % EDTA) was added to the kettle. When the kettle temperature reached 60° C., co-feeds including a solution of t-amylhydroperoxide (t-AHP 1.8 g), Disponil FES-32 emulsifier (0.5 g), and NaPS (5.0 g) mixed with DI water (100 g), along with a separate solution of isoascorbic acid (IAA, 2.6 g) in DI water (50 g) were both added simultaneously to the kettle over 77 minutes. Two min after the start of charging the co-feed solutions, ME 2, which was prepared by mixing DI water (200 g), Disponil FES-32 emulsifier (17.0 g), butyl acrylate (540.6 g), methyl methacrylate (471.8 g), and acrylic acid (15.3 g), was added to the kettle over 55 min while allowing the temperature to rise to 85° C. without providing any external heat. Upon completion of ME 2 addition, the co-feed solutions were stopped and the batch was held for 5 min at 85° C.

Upon completion of the hold, ME 3, which was prepared by mixing DI water (45 g), Disponil FES-32 emulsifier (3 g), butyl acrylate (91.5 g), methyl methacrylate (80.85 g), and 4-hydroxy TEMPO (3 g, 5 wt. % aq.), was fed to the kettle over 5 min. Immediately after the ME 3 feed addition was complete, NH₄OH (50.0 g, 28 wt. % aq.) mixed with DI water (10 g) was added to the kettle over 2 min. When NH₄OH addition was complete, the batch was held for 5 min. The addition the co-feed solutions was then resumed until completion. Additional co-feeds including a solution of t-AHP (1.45 g) and Disponil FES-32 emulsifier (0.5 g) in DI water (15 g), along with a separate solution of IAA (0.7 g) in water (16.2 g) were both added simultaneously to the kettle over 25 minutes. Upon completion of addition of the second co-feed, the dispersion was cooled to 25° C. With temperature less than 50° C., a solution of Acrysol ASE-60 (6.65 g in 65 g water) was then added to the kettle over a period of 10 minutes. The dispersion was filtered to remove any coagulum. The filtered opaque acrylic dispersion (OAP) had a solids content of 54.9%. The S/mil was measured to be 1.21.

### Inventive Binder 3:

A 5-liter, four necked round bottom flask was equipped a paddle stirrer, thermometer, N₂ inlet and reflux condenser. DI water (725 g) was added to the kettle and heated to 87° C. under N₂. Sodium persulfate (NaPS, 1.9 g in 20 g water) was added to vessel immediately followed by Core #1 (125 g). Monomer emulsion 1 (ME 1), which was prepared by mixing DI water (125 g), Disponil FES-32 emulsifier (10 g), styrene (436.8 g), acrylonitrile (112 g), linseed oil fatty acid (2.8 g), and divinylbenzene (80%, 7.0 g), was then added to the kettle over 85 min. The temperature of the reaction mixture was allowed to increase to 84° C. after 15 min and allowed to increase to 92° C. after 30 minutes. 2 minutes after the start of ME 1 addition, a solution of acrylic acid (5.6 g) in DI water (20 g) was added to the flask. 15 minutes after start of ME 1, a solution of 0.5 g NaPS in 30 g water was added to the kettle over 60 minutes. Upon completion of the ME 1 feed, the reaction was cooled to 60° C.

When the kettle temperature reached 80° C., an aqueous mixture of ferrous sulfate and EDTA (13.3 g, 0.15 wt. % FeSO₄, and 2 g, 1 wt. % EDTA) was added to the kettle. When the kettle temperature reached 70° C., 21.45 g of a separately prepared polymer (33% solids, 45 nm weighted average particle size) comprised of ethyl acrylate and methyl methacrylate was added to the kettle. When the kettle temperature reached 60° C., co-feeds including a solution of t-butylhydroperoxide (t-BHP 2.38 g) and NaPS (6.25 g) mixed with DI water (125 g), along with a separate solution of isoascorbic acid (IAA, 3.25 g) in DI water (125 g) were both added simultaneously to the kettle over 77 minutes. Two min after the start of charging the co-feed solutions, ME 2, which was prepared by mixing DI water (360 g), Disponil FES-32 emulsifier (25.5 g), butyl acrylate (810.9 g), methyl methacrylate (696.15 g), benzophenone (14.4 g) and acrylic acid (22.95 g), was added to the kettle over 55 min while allowing the temperature to rise to 85° C. without providing any external heat. 37 minutes after start of ME 2, 19.2 g of 1-dodecanethiol was added to ME 2 with good mixing. Upon completion of ME 2 addition, the co-feed solutions were stopped and the batch was held for 5 min at 85° C.

Upon completion of the hold, ME 3, which was prepared by mixing DI water (81.0 g), Disponil FES-32 emulsifier (4.5 g), butyl acrylate (145.5 g), methyl methacrylate (124.5 g), and 4-hydroxy TEMPO (4.5 g, 5 wt. % aq.), was fed to the kettle over 5 min. Immediately after the ME 3 feed addition was complete, NH₄OH (57.5 g, 28 wt. % aq.) mixed with DI water (55 g) was added to the kettle over 2 min. When NH₄OH addition was complete, the batch was held for 5 min. The addition the co-feed solutions was resumed until completion. Additional co-feeds including a solution of t-BHP (1.5 g) in DI water (25 g), along with a separate solution of IAA (0.7 g) in water (25 g) were both then added simultaneously to the kettle over 25 minutes. Upon completion of addition of the second co-feed, the dispersion was cooled to 25° C. With temperature less than 40° C., a solution of Acrysol ASE-60 (13.35 g in 53 g water) was then added to the kettle over a period of 10 minutes. The dispersion was filtered to remove any coagulum. The filtered opaque acrylic dispersion (OAP) had a solids content of 48.2%.

### Inventive Binder 4:

A 5-liter, four necked round bottom flask was equipped a paddle stirrer, thermometer, N₂ inlet and reflux condenser. DI water (725 g) and Polystep A-16-22 emulsifier (3.61 g) was added to the kettle and heated to 86° C. under N₂. Sodium persulfate (NaPS, 1.9 g in 20 g water) was added to vessel immediately followed by Core #1 (128.6 g). Monomer emulsion 1 (ME 1), which was prepared by mixing DI water (125 g), Disponil FES-32 emulsifier (10 g), styrene (436.8 g), acrylonitrile (112 g), linseed oil fatty acid (2.8 g), acrylic acid (5.6 g), and divinylbenzene (80%, 7.0 g), was then added to the kettle over 85 min. The temperature of the reaction mixture was allowed to increase to 84° C. after 40 minutes and then allowed to increase to 92° C. after 55 minutes. 40 minutes after the start of ME 1 addition, a solution of 0.5 g NaPS in 30 g water was added to the kettle over 45 minutes. Upon completion of the ME 1 feed, the reaction was cooled to 60° C.

When the kettle temperature reached 60° C., an aqueous mixture of ferrous sulfate and EDTA (20 g, 0.1 wt. % FeSO₄, and 2 g, 1 wt. % EDTA) was added to the kettle. Co-feeds including a solution of t-butylhydroperoxide (t-BHP 1.9 g) and NaPS (5.0 g) mixed with DI water (100 g), along with a separate solution of isoascorbic acid (IAA, 2.6 g) in DI water (100 g) were both added simultaneously to the kettle over 77 minutes. Two min after the start of charging the co-feed solutions, ME 2, which was prepared by mixing DI water (240 g), Disponil FES-32 emulsifier (17.0 g), butyl acrylate (540.6 g), methyl methacrylate (464.1 g), and methacrylic acid (23 g), was added to the kettle over 55 min while allowing the temperature to rise to 85° C. without providing any external heat. Upon completion of ME 2 addition, the co-feed solutions were stopped and the batch was held for 5 min at 85° C.

Upon completion of the hold, a solution of NH₄OH (5 g, 28 wt. % aq.) mixed with DI water (5.0 g) was then added to the kettle. ME 3, which was prepared by mixing DI water (54.0 g), Disponil FES-32 emulsifier (3 g), butyl acrylate (97 g), methyl methacrylate (83 g), and 4-hydroxy TEMPO (4 g, 5 wt. % aq.), was then fed to the kettle over 5 min. Immediately after the ME 3 feed addition was complete, NH₄OH (45.0 g, 28 wt. % aq.) mixed with DI water (35 g) was added to the kettle over 2 min. When NH₄OH addition was complete, the batch was held for 5 min. The addition the co-feed solutions was resumed until completion. Additional co-feeds including a solution of t-BHP (1.5 g) in DI water (25 g), along with a separate solution of IAA (0.7 g) in water (25 g) were both subsequently added simultaneously to the kettle over 30 minutes. Upon completion of addition of the second co-feed, the dispersion was cooled to 25° C. While cooling, and with temperature <50° C., a solution of Acrysol ASE-60 (13.35 g in 53 g water) was then added to the kettle over a period of 10 minutes. The dispersion was filtered to remove any coagulum. The filtered opaque acrylic dispersion (OAP) had a solids content of 48.4%. The S/mil was measured to be 1.32.

### Fast-Drying Paint Compositions:

To compare the performance of the bimodal binder compositions according to embodiments of the present invention, fast-drying paint compositions were prepared using both the bimodal binder compositions (Inventive Binder 1) and comparative binder compositions (Comparative Binders 1 to 3). Comparative Examples 1 and 2 (CE1 and CE2) incorporated a conventional binder (Comparative Binder 1) using 7.1 wt. % and 0 wt % TiO₂, respectively. Comparative Example 3 (CE3) incorporated a unimodal binder comprising a hollow core (Comparative Binder 2). Comparative Example 4 (CE4) incorporated a mixture of a hollow core binder and a conventional binder (Comparative Binder 3). Example 1 (E1) incorporated a bimodal binder composition (Inventive Binder 1) according to an embodiment of the present invention. The formulations are shown below in Table 1.

TABLE 1
COATING DESCRIPTION

| | | | | | |
|---|---|---|---|---|---|
| Binder | CE1 | CE2 | E1 | CE3 | CE4 |

ADD ALL MATERIALS UNDER MIXING.

| | | | | | |
|---|---|---|---|---|---|
| Comparative Binder 1 | 652.6 | 652.6 | — | — | 217.5 |
| Inventive Binder 1 | — | — | 681.0 | — | — |
| Comparative Binder 2 | — | — | — | 682.4 | — |
| Comparative Binder 3 | — | — | — | — | 550.6 |
| Tamol 901 (30%) | 7.1 | 7.1 | 7.1 | 7.1 | 7.1 |
| Surfynol ™ CT-136 Proprietary acetylenic surfactant blend | 4.0 | 4.0 | 4.0 | 4.0 | 4.0 |
| Drewplus ™ L-493 Mineral oil based foam control agent | 4.3 | 4.3 | 4.3 | 4.3 | 4.3 |
| TiPure R-900 Titanium dioxide pigment (rutile) | 142.1 | — | — | — | — |
| Hubercarb Q6 Calcium carbonate | 1080.9 | 1176.6 | 1176.6 | 1176.6 | 1176.6 |

DISPERSE FOR 15 MINUTES, THEN ADD THE FOLLOWING WITH GOOD MIXING.

| | | | | | |
|---|---|---|---|---|---|
| Methanol | 42.6 | 42.6 | 42.6 | 42.6 | 42.6 |
| Texanol | 16.3 | 16.3 | 16.3 | 16.3 | 16.3 |
| Drewplus ™ L-493 Mineral oil based foam control agent | 3.6 | 3.6 | 3.6 | 3.6 | 3.6 |

MIX FOR 5 MINUTES, THEN THICKEN TO VISCOSITY OF 80-90 KU.

| | | | | | |
|---|---|---|---|---|---|
| Water | 19.7 | 7.9 | 50.0 | 30.9 | — |
| QP-52000H (2% solution in water) | 28.3 | 40.0 | 53.5 | 56.2 | 60.00* |

MIX FOR 5 MINUTES.
*required to reach KU >80

Each of the fast-drying paint formulations was then tested using the test methods outlined above. The results are shown below in Table 2.

TABLE 2
PAINT PROPERTIES

| | Desired | | | | | |
|---|---|---|---|---|---|---|
| | Value | CE1 | CE2 | E1 | CE3 | CE4 |
| Volume Solids, | 62.0 | 62.0 | 62.0 | 62.0 | 62.0 | 58.8\hat{ } |
| additives included (%) | | | | | | |
| TiO₂ Level (%) | 0.0 | 7.1 | 0.0 | 0.0 | 0.0 | 0.0 |
| Viscosity (KU) | 80-90 | 84 | 89 | 85 | 88 | 81 |
| Dry to No Pick Up (min) | <10 | 6.0 | 5.5 | 7.5 | 4.5 | >15 |
| L* - over black - 8 mil | >85.0 | 91.6 | 64.6 | 89.7 | 90.1 | 88.6 |
| opening | | | | | | |
| Freeze Thaw Stability (# | >4 | >4 | >4 | >4 | 1 | 3 |
| of cycles to KU rise > 10) | | | | | | |

\hat{ }required to reach KU > 80

As seen in Table 2, only Inventive Example 1 (E1) comprising a bimodal binder composition according to an embodiment of the present invention provided satisfactory results in all of the tests when using less than 7 wt. % TiO₂.

A second series of fast-drying paint formulations was prepared to test various TiO₂ loadings with a bimodal binder composition according to an embodiment of the present invention. In Examples 2 to 6 (E2 to E6) below, Inventive Binder 3 was incorporated into each of the formulations as shown in Table 3.

TABLE 3
COATING DESCRIPTION

| | E2 | E3 | E4 | E5 | E6 |
|---|---|---|---|---|---|
| Formulation | 0% TiO2 | 1% TiO2 | 3% TiO2 | 5% TiO2 | 7% TiO2 |
| Inventive Binder 3 (Batch A: 48.3% solids by | 988.78 | 201.57 | 1085.37 | 1085.37 | 1085.37 |
| weight)* | | | | | |
| Inventive Binder 3 (Batch B: 48.2% solids by | 96.79 | 885.85 | — | — | — |
| weight)* | | | | | |
| Disponil ® FES-993 (30%) | 17.48 | 17.48 | 17.48 | 17.48 | 17.48 |
| p(OXEMA)\hat{ } polyfunctional amine (~27.5%) | 23.83 | 23.83 | 23.83 | 23.83 | 23.83 |
| TAMOL ™ 901 (30%) polyacid dispersant | 10.75 | 10.75 | 10.75 | 10.75 | 10.75 |
| Surfynol ™ CT-136 Proprietary acetylenic | 6.45 | 6.45 | 6.45 | 6.45 | 6.45 |
| surfactant blend | | | | | |
| Drewplus ™ L-493 Mineral oil based foam | 12.66 | 12.66 | 12.66 | 12.66 | 12.66 |
| control agent | | | | | |
| TiPure R-900 Titanium dioxide pigment | — | 32.45 | 97.34 | 162.23 | 227.13 |
| (rutile) | | | | | |
| Hubercarb G6 Calcium carbonate | 1848.43 | 1835.03 | 1808.25 | 1781.47 | 1754.68 |
| Methanol | 61.52 | 61.52 | 61.52 | 61.52 | 61.52 |
| Texanol | 26.21 | 26.21 | 26.21 | 26.21 | 26.21 |
| Water | 84.35 | 71.95 | 90.58 | 71.95 | 81.95 |
| Cellosize ™ QP-52000H (2% solution in | 67.51 | 78.41 | 62.01 | 80.04 | 70.27 |
| water) | | | | | |
| Silquest ™ A-2120 Silane | 5.24 | 5.24 | 5.24 | 5.24 | 5.24 |
| Total | 3249.98 | 3269.39 | 3307.68 | 3345.20 | 3383.53 |

*Different batches of Inventive Binder 3 were used (Batch A and Batch B). The amounts of Inventive Binder 3 incorporated into each formulation were adjusted to provide similar solids content of the binder throughout Examples 2 to 6.
\hat{ }p(OXEMA) is poly(oxazolidinoethylmethacrylate).

The viscosity and Y reflectance was measured for each of Examples 2 to 6, where a desired value of Y is at least 66. The results are shown in Table 4 below.

TABLE 4
PAINT PROPERTIES

| | | | | | |
|---|---|---|---|---|---|
| Viscosity (KU) | 81 | 84 | 78 | 80 | 80 |
| TiO2 Content | 0.0% | 1.0% | 2.9% | 4.8% | 6.7% |
| Y - over black - 8 mil | 77.59 | 78.58 | 82.89 | 85.6 | 87.36 |
| opening | | | | | |

1. A bimodal binder composition comprising:
a first mode comprising particles having an average particle size ranging from 200 nm to 650 nm, wherein the particles of the first mode contain at least one void;
a second mode comprising particles having an average particle size less than the average particle size of the particles of the first mode, wherein the particles of the second mode do not contain a void;
wherein the particles of the first mode and the particles of the second mode independently comprise a film forming polymer formed from, as polymerized units, one or more ethylenically unsaturated monomers.

2. The bimodal binder composition of claim 1, wherein the at least one void of the particles of the first mode has an average size ranging from 50 to 350 nm when dry.

3. The bimodal binder composition of claim 2, wherein the at least one void of the particles of the first mode has an average size ranging from 100 to 300 nm when dry.

4. The bimodal binder composition of claim 1, wherein the particles of the first mode have an average particle diameter ranging from 350 nm to 600 nm.

5. The bimodal binder composition of claim 1, wherein the particles of the second mode have an average particle diameter ranging from 50 to 250 nm.

6. The bimodal binder composition of claim 1, wherein the particles of the first mode comprise a multi-stage polymer comprising a core and at least one shell, wherein the at least one void of the particles of the first mode is present in the core.

7. The bimodal binder composition of claim 6, wherein an outermost shell of the particles of the first mode comprises the film forming polymer formed from, as polymerized units, one or more ethylenically unsaturated monomers.

8. The bimodal binder composition of claim 7, wherein film forming polymer of the outermost shell of the particles of the first mode has a glass transition temperature, Tg, of from −30° C. to 60° C.

9. The bimodal binder composition of claim 1, wherein the particles of the second mode comprise a polymer formed from, as polymerized units, one or more ethylenically unsaturated monomers over a seed particle.

10. The bimodal binder composition according to claim 1, wherein a ratio of the amount of the film forming polymer formed from, as polymerized units, one or more ethylenically unsaturated monomers in the particles of the first mode to the amount of film forming polymer formed from, as polymerized units, one or more ethylenically unsaturated monomers in the particles of the second mode ranges from 10:90 to 90:10.

11. The bimodal binder composition according to claim 10, wherein the ratio of the amount of the film forming polymer formed from, as polymerized units, one or more ethylenically unsaturated monomers in the particles of the first mode to the amount of film forming polymer formed from, as polymerized units, one or more ethylenically unsaturated monomers in the particles of the second mode ranges from 20:80 to 80:20.

12. The bimodal binder composition according to claim 11, wherein the ratio of the amount of the film forming polymer formed from, as polymerized units, one or more ethylenically unsaturated monomers in the particles of the first mode to the amount of film forming polymer formed from, as polymerized units, one or more ethylenically unsaturated monomers in the particles of the second mode ranges from 30:70 to 70:30.

13. The bimodal binder composition according to claim 1, wherein a ratio of the average particle size of the particles of the second mode to the average particle size of the particles of the first mode ranges from 0.1:1 to 0.9:1.

14. The bimodal binder composition according to claim 13, wherein the ratio of the average particle size of the particles of the second mode to the average particle size of the particles of the first mode ranges from 0.2:1 to 0.8:1.
